(19) United States
(12) Patent Application Publication
(10) Pub. No.: US 2024/0284889 A1
(43) Pub. Date: Aug. 29, 2024

(54) LIGHTED FISHING POLE TIP APPARATUS

(71) Applicant: DANIEL LEE MORGAN, JR., Des Moines, IA (US)

(72) Inventor: DANIEL LEE MORGAN, JR., Des Moines, IA (US)

(21) Appl. No.: 18/176,477

(22) Filed: Feb. 28, 2023

(51) Int. Cl. A01K 97/00; F21V 33/00

(52) U.S. Cl. CPC A01K 97/00; A01K 87/007; A01K 87/04; F21V 33/00

(57) ABSTRACT

This invention is for the purpose of helping low level light or night time fishing to be made easy to see the activity of the fishing pole for determining when a fish is biting. It constructed in such a way as to allow the light to be aimed back to the fisherman, the lighted fishing pole apparatus is molded around the last eyelet of the fishing pole and allows the string to feed through the last eyelet as normal. The Light/LED is also housed inside of this housing, There is a power supply in the form of a battery that provides voltage through a switch in which both are inside the handle. Wires are attached from the battery to the switch and then to the Light/LED in the housing. This invention also makes it easier to manufacture and with modifications provide for installation on existing fishing poles.

### PRIOR ART

(1) All prior art differs from the Lighted fishing pole tip apparatus mentioned above, most fall into two categories, fiber optic and Lights bulbs/LED. U.S. Pat. No. 10,986,824 B1 Walters, U.S. Pat. No. 5,566,493 Minorics, US 2011/0162253 A1 Cobb, U.S. Pat. No. 5,738,433 Sparks, U.S. Pat. No. 5,172,508 Schmidt, and U.S. Pat. No. 4,369,486 Pool, either light up one or more eyelets or the whole fishing pole. U.S. Pat. No. 10,986,824 B1 Walters, Illuminates up to the tip, along with the others this can make for difficult manufacturing to accomplish what they desire, also it does not accomplish what the above invention accomplishes. (2) U.S. Pat. No. 8,104,219 B1 Pace, U.S. Pat. No. D871,542 S Barrett, U.S. Pat. No. 7,337,577 B1 Ramirez, US 2007/0283612 A1 Shaw, Nahrgang, Gou U.S. Pat. No. 7,614,177 B1 Wheeler, U.S. Pat. No. 6,000,808 Hansen, U.S. Pat. No. 4,775,920 Seibert, Zindars, U.S. Pat. No. 5,357,410 Cote & Cota, All have either a Light/LED inside the handle or externally attached to the pole. These all either make it difficult to manufacture and/or do not accomplish what the above invention does.

### BACKGROUND OF THE INVENTION

The background of this invention is in the area of low level light or night fishing, and involves a fishing pole equipped with some sort of light attachment built in or around a fishing pole to help in the aid of visually identifying the movement of the fishing pole when a fish strikes the bait and allowing the fisherman to react and catch the fish.

### SUMMARY OF THE INVENTION

This Lighted fishing pole tip apparatus is for the purpose of giving the fisherman the best possible view of the last eyelet in which is the most noticeable movement available when a fish is biting, and because of its angle it is very efficient at doing this whether the fishing pole is up right or upside down, there is no other apparatus like it. Due to its construction and position on the fishing pole it can be included in the manufacturing process or retrofitted on existing poles with some modifications, and it allows for the normal use of the last eyelet. The lighted fishing pole tip apparatus is supplied electricity by batteries in the handle through a switch and wires inside the pole.

### BRIEF DESCRIPTION OF DRAWINGS

FIGS. 1, and 2. show an enlarged detailed view of the lighted fishing pole apparatus/housing assembly on the last eyelet.

FIG. 3. Is a closer to actual size, but can vary due to the fishing pole size.

FIG. 4. shows the basic overall fishing pole.

### DETAILED DESCRIPTION OF THE INVENTION

FIG. 1. shows an enlarged side view of the lighted fishing pole apparatus/housing 1 shows the Light/LED molded inside of the housing. 2 shows the housing molded around the last eyelet. 3 shows the fishing pole going into the lighted fishing pole apparatus/housing. 4 shows the hole/opening (in between the dashed lines) that passes through the last eyelet leaving access for the fishing strings normal passage and usage. 5 shows the last eyelets position in the housing.

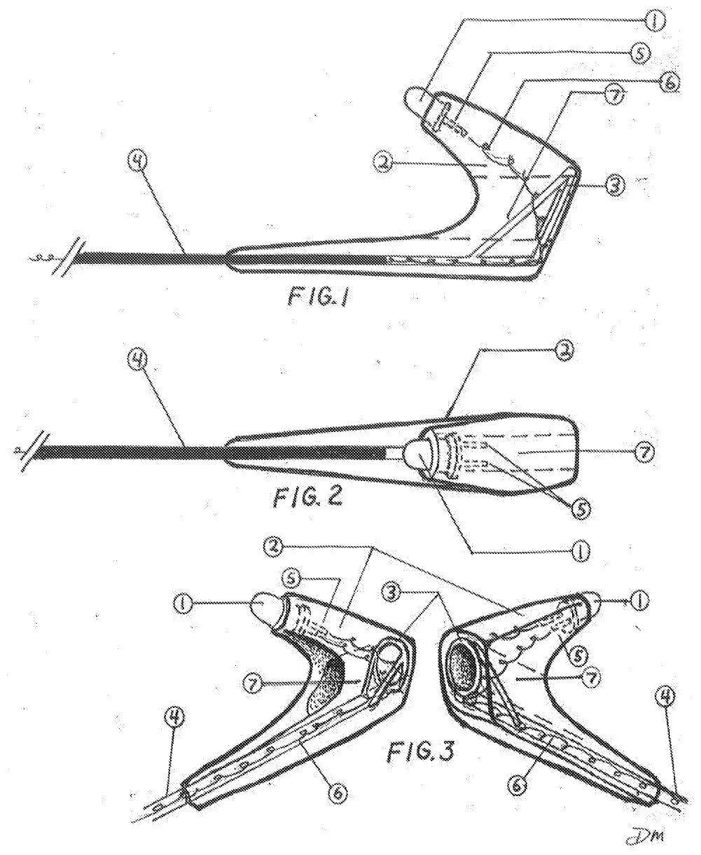

FIG. 2. shows the top view of the lighted fishing pole apparatus/housing. 1 shows the Light/LED. 2 shows the housing. 3 shows the fishing pole attached to the lighted fishing pole apparatus/housing.

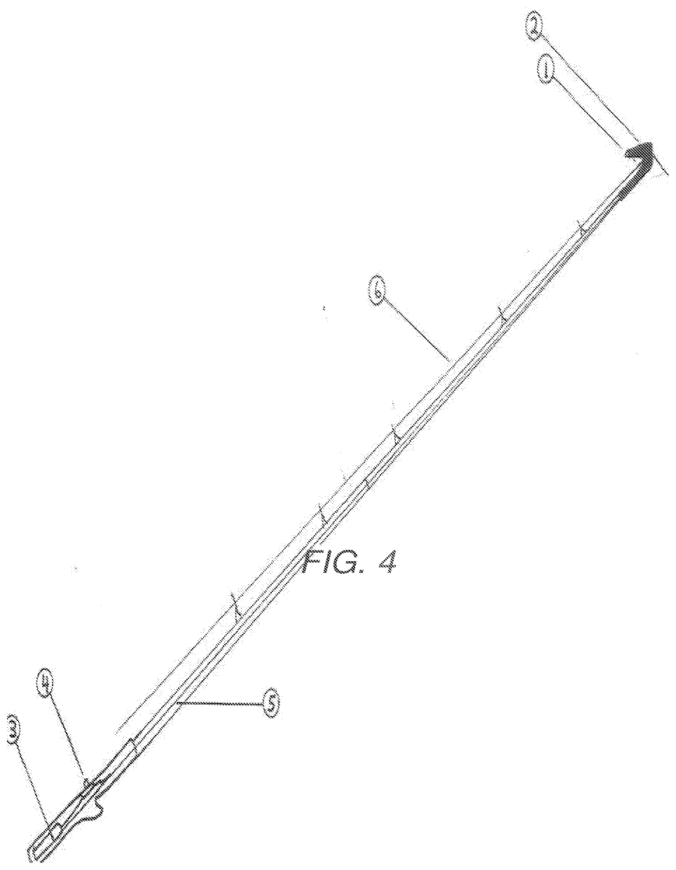

FIG. 3. shows a more actual size of the lighted fishing pole apparatus/housing with a side view and top view. 1 shows the Light/LED 2 shows the housing. 3 shows shows the fishing pole attached to the lighted fishing pole apparatus/housing. 4 shows an approximate 45 degree angle of the Light/LED to the fishing pole.

FIG. 4. shows the basic configuration needed to supply power to the lighted fishing pole apparatus/housing. 1 shows the Light/LED positioned in the housing at an approximately 45 degree angle to the fishing pole. 2 shows the housing. 3 shows a basic power source (battery) location. 4 shows an electric on/off switch location to control power to the Light/LED 5 shows a basic path for the wires that supply the power to the Light/LED.

FIG. 4 shows the basic configuration needed to supply power to the lighted fishing pole apparatus/housing. 1 shows the Light/LED positioned in the housing at an angle approximately a 45-degree angle to the fishing pole handle 2 shows the housing 3 shows the power source (batteries) location 4 shows the on/off switch location to control power to the Light/LED 5 shows a path for the wires used to supply the power to the Light/LED.

1. The object of this invention is to provide a lighted fishing pole tip apparatus that lifts the light away from the pole to improve visibility in the upright and upside-down position of the fishing pole.
